(19) United States
(12) Patent Application Publication
(10) Pub. No.: US 2005/0133171 A1
(43) Pub. Date: Jun. 23, 2005

(54) Adjustable transmission device for a vertical rolling door

(76) Inventor: Kenneth S. Fan, Miaoli Hsien (TW)

Correspondence Address: DELLETT AND WALTERS, P. O. BOX 2786, PORTLAND, OR, 97208-2786, US

(21) Appl. No.: 10/743,445

(22) Filed: Dec. 20, 2003

(51) Int. Cl. E06B 9/56

(52) U.S. Cl. 160/313

(57) ABSTRACT

An adjustable transmission device for a vertical rolling door has a bracket, a driving device and two adjustable spring devices. The driving device has at least one torsional spring used for pulling the vertical rolling door up. When the transmission device is mounted, a user can adjust the torque of the torsional spring by the adjustable spring devices.

### BACKGROUND OF THE INVENTION

1. Field of Invention

The present invention relates to a transmission device for a vertical rolling door, and more particularly to an adjustable transmission device for a vertical rolling door.

2. Description of the Related Art

A conventional automatic transmission device for a vertical rolling door is used to pull the vertical rolling door up or roll the vertical rolling door down and has a bracket with two holders, a shaft, two rollers, a motor and two torsional springs. The shaft is transversely mounted between the holders. The shaft has two ends, and the rollers are mounted rotatably respectively on the ends of the shaft. The motor is connected to one of the rollers. When the motor drives the vertical rolling door down, the roller is also driven by the motor so that the torsional spring is rotated to increase torque. When the motor drives the vertical rolling door up, the torque in the torsional spring will decrease as the vertical rolling door moves up.

When workers assemble the transmission device for a vertical rolling door, the torque in the torsional spring when the door is down depends on the height of the door. When the shaft, the torsional spring and the rollers are assembled, the torque in the torsional spring is not easy to change, and the whole transmission device must be taken down and assembled again, which takes time and is not convenient.

To overcome the shortcomings, automatic transmission devices for vertical rolling doors that can adjusted with the vertical rolling door in place are still needed, and an automatic transmission device for a vertical rolling door in accordance with the present invention obviates or mitigates the aforementioned problems.

### SUMMARY OF THE INVENTION

The primary objective of the present invention is to provide an adjustable transmission device for a vertical rolling door.

To achieve the objective, the adjustable transmission device for a vertical rolling door in accordance with the present invention has a bracket, a driving device and adjustable spring devices. The driving device has at least one torsional spring used for pulling the vertical rolling door up. When the transmission device is mounted, a user can adjust the torque of the torsional springs by the adjustable spring devices.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an adjustable transmission device for a vertical rolling door in accordance with the present invention;

FIG. 2 is an enlarged exploded perspective view of the transmission device in FIG. 1;

FIG. 3 is a front plan view of the transmission device in partial section in FIG. 1 with two shaft locks engaging the shaft;

FIG. 4 is a front plan view of the transmission device in partial section in FIG. 1 with one shaft lock engaging the shaft; and

FIG. 5 is a front plan view of the transmission device in partial section in FIG. 1 with one shaft lock engaging the shaft and the base fasteners removed from the base of the other adjustable spring device.

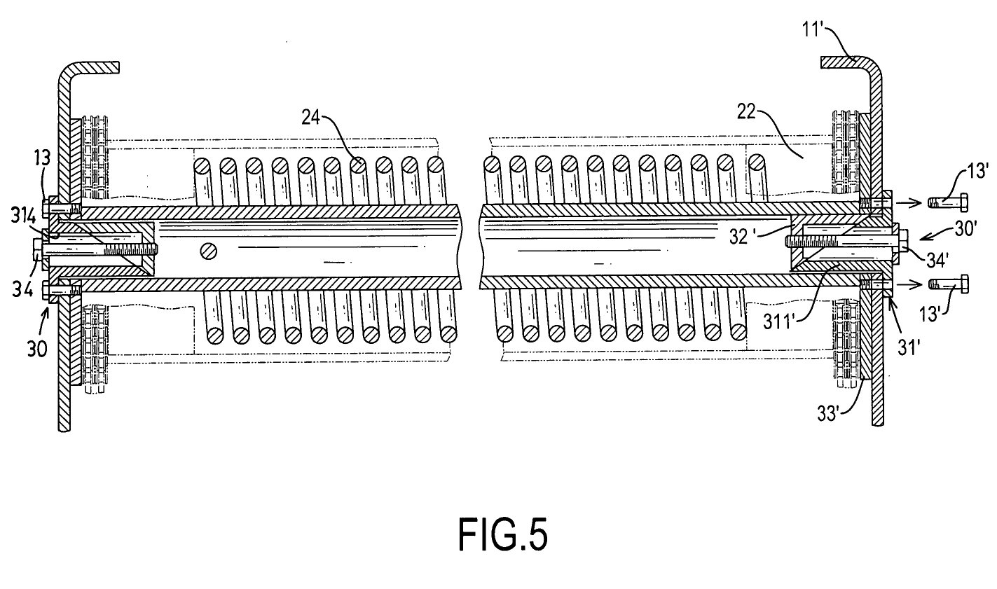

### DETAILED DESCRIPTION OF THE INVENTION

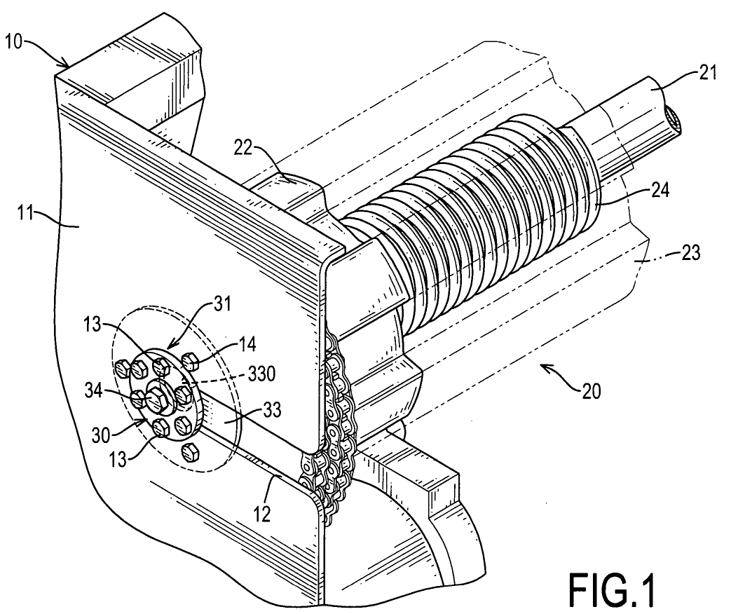

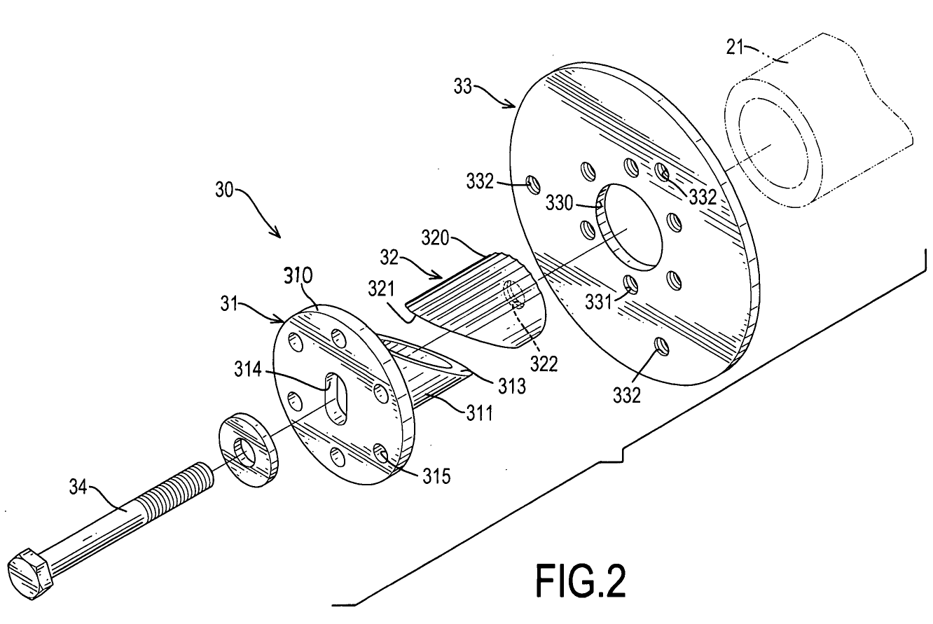

With reference to FIGS. 1 to 3, an adjustable transmission device for a vertical rolling door in accordance with the present invention has a bracket (10), a driving device (20) and two adjustable spring devices (30,30′).

The bracket (10) has two side holders (11). Each side holder (11) has an inner surface (not numbered), an outer surface (not numbered) and a slot (12) defined through the side holder (11).

The driving device (20) is mounted inside the bracket (10) between the side holders (11) and has a shaft (21), two rollers (22), a connector (23) and at least one torsional spring (24). The shaft (21) is mounted between the side holders (11) and has two ends (not numbered). The rollers (22) are mounted respectively on the ends of the shaft (21). The connector (23) is mounted around and connected to the rollers (22), so that the rollers (22) rotate together with the shaft (21) inside the connector (23). The torsional spring (24) is mounted around the shaft (21) and has a stationary end (not numbered) and a rotating end (not numbered). The rotating end of the torsional spring (24) is attached to one of rollers (22), and the stationary end is attached to the shaft (21). When the rollers are rotated to lower the vertical rolling door, the torsional springs (24) will store torque that pulls the vertical rolling door up. The structure and operations of the shaft (21), the rollers (22) and the torsional springs (24) are conventional and are not described further.

The adjustable spring devices (30,30′) are attached respectively to the side holders (11) of the bracket (10) and opposite ends of the driving device (20). Each adjustable spring devices (30,30′) has a base (31,31′), a shaft lock (32,32′), an inner base (33,33′), a locking bolt (34,34′), a washer (not numbered), multiple base fasteners (13,13′) and multiple optional inner base fasteners (14,14′).

The base (31,31′) is attached to the outer surface of the side holder (11), is mounted in the slot (12) in the side holder (11) and has a tube (311,311′) and a mounting plate (310,310′). The tube (311,311′) is mounted through the slot (12) in the side holder (11), extends into the shaft (21) and has a proximal end (not numbered) and a distal end (not numbered). The distal end has a stationary inclined surface (313,313′) and extends into the shaft (21). The mounting plate (310,310′) is formed on the proximal end of the tube (311,311′), abuts the outer surface of the side holder (11) and has a center (not numbered), an inside surface (not numbered), an outside surface (not numbered), multiple through holes (315,315′) and an elongated slot (314,314′). The inside surface is attached to the proximal end of the tube (311,311′) around the center. The through holes (315,315′) are equally spaced around the center of the mounting plate (310,310′). The elongated slot (314,314′) is defined at the center of the mounting plate (310,310′).

The shaft lock (32,32′) is connected to the distal end of the tube (311,311′) of the base (31,31′) inside the shaft (21), is tubular and has an open end (not numbered), a closed end (not numbered), an outside surface (not numbered) and multiple longitudinal ribs (320,320′). The open end has a sliding inclined surface (321,321′) that forms a long side (not numbered). The sliding inclined surface (321,321′) abuts the stationary inclined surface (313,313′). The multiple longitudinal ribs (320,320′) are defined on the long side of the outside surface of the shaft lock (32,32′). The closed end of the shaft lock (32,32′) has a threaded lock hole (322,322′). When the shaft lock (32,32′) is attached to the base (31,31′) and the sliding inclined surface (321,321′) abuts the stationary inclined surface (313,313′), the threaded lock hole (322,322′) in the shaft lock (32,32′) is aligned with the elongated slot (314,314′) in the mounting plate (310,310′).

The inner base (33,33′) is mounted around the tube (311,311′) of the base (31,31′) and the shaft lock (32,32′) and abuts the inner surface of the side holder (11). The inner base (33,33′) has a central hole (330,330′), multiple threaded base holes (331,331′) and multiple optional threaded inner base holes (332,332′). The threaded base holes (331,331′) are equally spaced around the central hole (330,330′) and correspond to the through holes (315,315′) in the mounting plate (310,310′) of the base (31,31′). The base fasteners (13,13) pass through the through holes (315,315′) and screw into the threaded base holes (331,331′) to attach the base (31,31′) to the side holder (11). The optional threaded inner base holes (332,332′) are equally spaced around the threaded base holes (331,331′). The optional inner base fasteners (14) pass through the side holders (11) and screw into the threaded inner base holes (332,332′) to attach the inner bases (33,33′) respectively to the inner surfaces of the side holders (11). The optional threaded inner base holes (332,332′) are formed on radii that do not pass through any threaded base holes (331,331′). The base fasteners (13) are screwed respectively into the threaded base holes (331,331′), and the optional inner base fasteners (14) are screwed respectively into the threaded inner base holes (332,332′).

The locking bolt (34,34′) passes through the elongated slot (314,314′) in the mounting plate (310,310′) of the base (31,31′), and the central hole (330,330′) of the inner base (33,33′) and screws into the threaded lock hole (322,322′) in the shaft lock (32,32′).

When the bracket (10), the driving device (20) and the adjustable spring device (30,30′) are assembled, the longitudinal ribs (320,320′) on two shaft locks (32,32′) are pulled against the inner surface of the shaft (21) to keep shaft (21) and the stationary ends of the torsional springs (24) from rotating with the rollers (22). When the rollers (22) are rotated to lower the vertical sliding door, torque is stored in the torsional springs (24) to pull the vertical rolling door up.

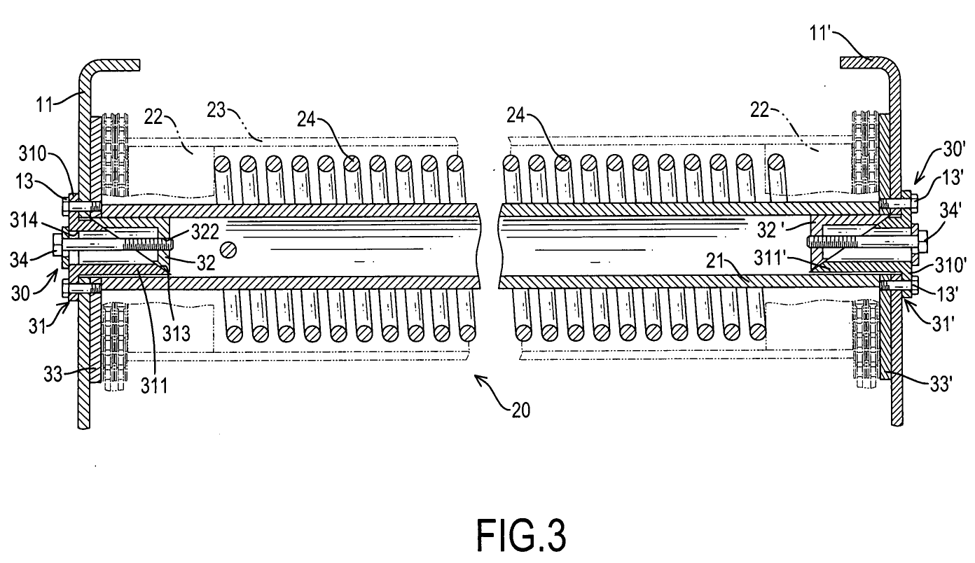

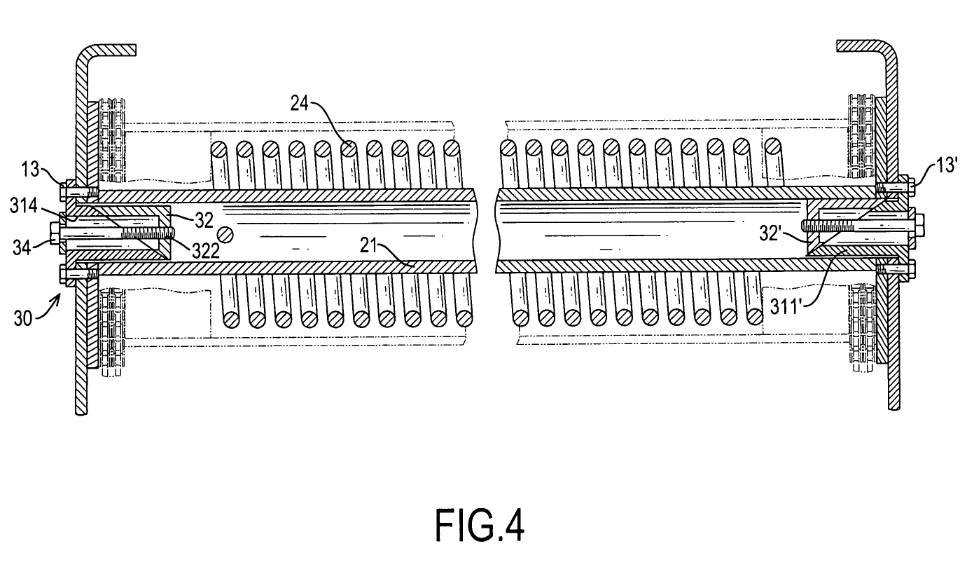

With reference to FIGS. 3 and 4, the torque in the torsional springs (24) is adjusted by loosening one of the locking bolts (34) mounted through one side of the adjustable device (30) to release the corresponding shaft lock (32) from the inner surface of the shaft (21). Then the base fasteners (13′) on the other adjustable spring device (30,30′) are removed to disconnect the base (31′) from the side holder (11′) and the inner base (33′). With the shaft lock (32′) securely abutting the inner surface of the shaft (21), the base (31′) and the shaft (21) are rotated to apply a torque and store a torsional force in the torsional springs (24). After the torque in the torsional springs (24) is adjusted, the locking bolt (34) is tightened to hold the shaft (21) in position and the base fasteners (13′) are reinstalled.

The adjustable transmission device for the vertical rolling door has the following advantages.

The entire transmission device does not have to be removed to adjust the torque in the torsional springs. Only the adjustable spring device (30) has to be manipulated to accomplish the task. The adjustable transmission device provides a convenient way to adjust the torque in the torsional springs (24).

The invention may be varied in many ways by a person skilled in the art. Such variations are not to be regarded as a departure from the spirit and scope of the invention, and all such modifications are intended to be included within the scope of the following claims.

1. An adjustable transmission device for a vertical rolling door comprising
a bracket having two side holders, each side holder having
an inner surface,
an outer surface, and
a slot defined through the side holder,
a driving device mounted inside the bracket and having
a shaft mounted between the side holders and having two ends,
two rollers mounted respectively on the ends of the shaft,
a connector mounted around and connected to the rollers so the rollers rotate together with the shaft inside the connector, and
at least one torsional springs, each one of the at least one torsional spring mounted around the shaft having a rotating end attached to one of the rollers and a stationary end attached to the shaft, and
two adjustable spring devices attached respectively to the side holders of the bracket, each adjustable spring device having
a base attached to the outer surface of a corresponding one of the side holders, mounted in the slot in the corresponding side holder and having a tube mounted through the slot in the corresponding side holder, extending into one end of the shaft and having a distal end with a stationary inclined surface and a proximal end, and
a mounting plate attached to the proximal end of the tube, abutting the outer surface of the corresponding side holder and having
a center;
an inside surface attached to the proximal end of the tube around the center;
an outside surface;
multiple through holes equally spaced around the center of the mounting plate; and
an elongated slot at the center;
a shaft lock connected to the distal end of the tube of the base inside the shaft, being tubular and having
an open end having a sliding inclined surface that forms a long side, the sliding inclined surface abutting against the stationary inclined surface;
a closed end having a threaded lock hole aligned with the elongated slot when the sliding inclined surface abuts the stationary inclined surface;
an outside surface, and
multiple longitudinal ribs formed on the long side of the outside surface;
an inner base mounted around the tube of the base and the shaft lock, abutting the inner surface of the corresponding side holder and having
a center,
a central hole defined at the center of the inner base, and
multiple threaded base holes equally spaced around the central hole,
a locking bolt passing through the elongated slot in the mounting plate and the central hole in the inner base and screws into the threaded lock hole in the shaft lock, and
multiple base fasteners, each base fastener passing through one of the threaded base holes and screwed into a corresponding one of the threaded base holes.

2. The adjustable transmission device as claimed in claim 1, wherein each adjustable spring device further comprises inner base fasteners, and
the inner base further comprises multiple threaded inner base holes equally spaced around the threaded base holes, wherein each inner base fastener is inserted into one of the threaded inner base holes.
